(19) United States
(12) Patent Application Publication
(10) Pub. No.: US 2009/0165148 A1
(43) Pub. Date: Jun. 25, 2009

(54) METHOD FOR AUTHENTICATING APPLICATIONS OF A COMPUTER SYSTEM

(76) Inventors: Alexandre Frey, Paris (FR); Axelle Apvrille, Roquefort Ies Pins (FR)

Correspondence Address: BROWDY AND NEIMARK, P.L.L.C.;624 NINTH STREET, NW, SUITE 300, WASHINGTON, DC, 20001-5303, US

(21) Appl. No.: 12/158,992

(22) PCT Filed: Dec. 22, 2006
(86) PCT No.: PCT/FR06/02871

§ 371 Date: Nov. 3, 2008

(30) Foreign Application Priority Data
Dec. 23, 2005 (FR) 0513247

(51) Int. Cl. G06F 21/00

(52) U.S. Cl. 726/30

(57) ABSTRACT

The invention relates to a method for authenticating applications of a computer system including: a microprocessor, a plurality of applications, a general operating system (OS2) which can execute and manage the applications and which can associate each application identifier (3) with the identification information required for the execution thereof, and a trusted environment (EC) which offers services to said applications. According to the invention, before the services of the trusted environment (EC) can be accessed by an application, a hashing operation is performed on the identification information of said application and the trusted environment (EC) checks the authenticity of the result of the hashing operation.

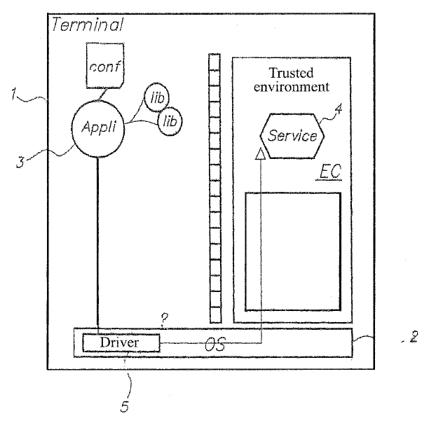

The invention relates to a method for authenticating applications of a computer system.

A computer system is considered in which a certain number of “trusted” services operate in a secure local environment (Trusted Environment). These services offer functions which may be accessed from outside the Trusted Environment. The aim is therefore to control who (and which application) has the right to access each function.

For example, the case of a digital rights management (DRM) agent may be used, which is executed in the Trusted Environment. This DRM agent manages the authorisation for reading MP3 files protected by a DRM license. This license includes, for example, rights to read the MP3 file up to a limited date. The DRM agent is responsible for verifying that the license conditions are respected. Operating in a Trusted Environment helps it in this mission: for example, it has guarantees as to the time and the date of the local system. If the conditions are respected, the DRM agent authorises the reading of the MP3 file. For this purpose, it must provide the standard MP3 player application (which is executed in a standard zone, which is to say outside of the Trusted Environment) the key to decode the MP3 file. Obviously, the DRM agent should not supply this key to an unknown MP3 player application (which for example, could post it on Internet . . . ). It may be seen from this example that the secure service (DRM agent) must authenticate the standard application (MP3 player) which invokes the reading of the MP3 file.

Furthermore, it is easy for a local service to authenticate another local application in closed environments, whether they are closed operating systems (which is to say in which all of the applications are installed initially, under the supervision of an administrator or an approved user) or execution environments. Indeed, if it is a closed operating system, the installation of the application itself is a guarantee of its authenticity as only authorised persons can carry out this operation. If it is an execution environment (virtual machine), the problem is only slightly more complicated as the format of the application is designed to provide the virtual machine with the means to verify its authenticity or integrity (by its construction, a virtual machine handles the code of the applications it executes).

The problem is much more complex in the case of an open system, where new applications may be downloaded freely and installed, and where there are many tools for developing, modifying, debugging and tracing applications. However, the need to find a solution is even more crucial as open systems are used more and more often, including in the field of embedded computing (or buried) systems such as for mobile telephones, portable multimedia players or PDAs (personal digital assistants).

Consequently, certain systems have chosen to integrate advanced security mechanisms within the operating systems. This is the case for example of the capabilities that are found in certain operating systems such as Linux, SELinux (registered trade marks) in particular, where the operating system integrates the notion of authorisation (example of authorisation: “an honest MP3 player application is authorised to use the services of a DRM agent”). This solution has several disadvantages:
It is intrusive: the entire operating system has to be based on and rewritten to include this notion. An operating system that is not programmed for this therefore has to undergo considerable modifications to include this.
The configuration of the authorisations is a permanent problem for the system administrator, as there are many exceptions that have to be made to the general case; furthermore, the authorisations may change in time;
The authentication of the application is entrusted to the operating system, which is not its role. The role of an operating system is to manage the tasks with respect to one another, not to carry out security operations. It is known that it is bad practice to entrust security processing to a generalist entity. On the contrary, they should be grouped in a dedicated, restricted module.

Other solutions, such as that of the “Trusted Computing” model are based on the presence of specific security hardware (Trusted Platform Module—TPM) and a cryptographic certification mechanism. In this case, the TPM is charged with providing an external entity with guarantees on the authenticity of the local system. However, the cryptographic certification is designed to provide guarantees on a global system and not on a given application (there are no systems using a TPM to authenticate a local application); furthermore, the addition of dedicated hardware is not necessarily possible in all situations (for technical and/or commercial reasons).

The specific purpose of the invention is therefore to eliminate these disadvantages by means of a method which permits guarantees to be provided locally, on an open operating system and without modifying it, on the authenticity of “standard” applications which are executed outside of the Trusted Environment, to secure services operating within the Trusted Environment, wherein this method permits three different levels of trust to be obtained:
a standard application (not secure)
an operating system (which has a certain level of privileges), and
trusted applications.

This method permits the authentication of applications of an operating system comprising:
a plurality of applications,
a generalist operating system capable of executing and managing said applications, and especially to associate to each application identifier the information required to execute it, called the “Identification Information”,
a Trusted Environment offering services to said applications.

According to the invention, prior to any access to the services of the Trusted Environment by an application, this method comprises the following operating phases:
the execution of a “hashing” operation on the Identification Information of said application;
the verification by the Trusted Environment of the authenticity of the Condensed result, of said “hashing” operation.

Advantageously, the process could further feature a “Driver” software component, permitting access to the Trusted Environment from the operating system, and the operations could then be carried out as follows:
the Driver provides the operating system with the identifier of the application;
the operating system provides the Driver with the Identification Information;
the Driver executes the “hashing” operation on the Identification Information and sends the Condensed result to the Trusted Environment.

Advantageously:
The above-mentioned Identification Information may comprise the executable code of the application and possibly certain file names and files used by the application.
The verification of the authenticity of the Condensed result by the Trusted Environment may be carried out by searching in a list of acceptable Condensed results.
The authentication operations may be carried out when the application request access to a service in the Trusted Environment.
The authentication operations may be carried out in a prior “log-in” phase, which permits the application to be authenticated prior to any request for access to the services of the Trusted Environment.
According to the result of the Condensed result, the Trusted Environment may provide the application with different access rights to its services.
The services offered by the Trusted Environment may include at least the access to certain resources of the computer system.

The resources of the computer system controlled by the Trusted Environment may include cryptographic encoding means.
The resources of the computer system controlled by the Trusted Environment may include rights to use certain contents (DRM).

Advantageously, the Trusted Environment (EC) may be executed in a secure microprocessor mode, which provides improved security guarantees.

The invention also relates to an authentication system for applications which uses the method defined above and may be executed on portable equipment such as a mobile telephone, an audio or video player, a PDA, etc.

One mode of execution of the invention will be described below, by way of non-restrictive example and in reference to the appended drawing in which:

The single FIGURE is a diagrammatical representation of the architecture of an authentication system according to the invention.

In this example, the terminal 1 uses:
an open operating system OS2 (such as in Linux, Window, Solaris, etc. (registered trade marks)). Of course, this OS2 operating system must be able to manage the applications that are to be authenticated. The “standard” (non-secure) applications are executed directly on this operating system. This operating system has two global levels of privileges (User mode/Kernel mode).
an EC Trusted Environment to execute the security services 4.

The switch from the OS2 operating system to the EC Trusted Environment is controlled by a Driver 5, which is to say a small module (or plug-in) which is executed in the kernel of the OS2 operating system.

This Driver is designed to intercept the access requests from a non-secure application (that is executed in the OS2 operating system) to a secure service 4 (that is executed in the Trusted Environment EC).

Following the interception of an access request, the Driver 5 sends to the OS2 operating system the identifier of the application and requests the file containing its executable code. Usually, the operating systems keep this information in a data structure called a process control block (PCB).

The Driver 5 executes a “hashing” operation (such as SHA-1) on the file provided by the OS2 operating system.

The OS2 operating system may further search in the file directory a “manifest” file, which contains the absolute name of all the important files that the application uses (for example a configuration file, a shared library, etc.) and supplies this information to the Driver 5. The Driver 5 then carries out the “hashing” operation, both on the executable manifest file and on all of the files referenced in the manifest file (or just on some of them).

In all cases, the Condensed result provides unique identification of the non-secure application (given that the “hashing” function enables crashes to be avoided). It is then sent to the Trusted Environment for verification of its authenticity. By way of example, the Condensed result may be compared to a list of acceptable Condensed results. If the Condensed result is found, the access to the services offered by the security service 4 may be authorised.

In the example described above, the OS2 operating system only intervenes to identify the files corresponding to the request for access to a service of the EC Trusted Environment and to search for the pertinent information, which falls entirely in the field of an operating system, and does not calculate the Condensed result or carry out an authentication check.

Furthermore, the EC Trusted Environment certificate may also not be based on the OS2 operating system and may be independent from it, as this single FIGURE is only one possible embodiment.

On the Linux (registered trade mark) operating system, the Driver 5 obtains the list of files related to the connection request in line with the following operating sequence, based on the observation that each process is viewed, within the Linux (registered trade mark) kernel, as a task (“struct task_struct”).
From the task corresponding to the process, the pages that this task has mapped in memory are obtained (“get_task_mm(task)”). Thus a “struct_mm_struct” is obtained.
Each of these pages is searched for a page marked executable (mm->mmap&VM_EXECUTABLE). The (reasonable) hypothesis is made here that this page belongs to the executable file which corresponds to the process.
The file is found that is associated to this page (mm->mmap->vm_file). In the Linux (registered trade mark) operating system, this is a “struct_file”.
A “hashing” operation is carried out on the content of the file found. If the use of a manifest file is introduced, then it is further necessary:
to obtain the path of this file: the various “dentrys” associated to the file (vm_file->fγdentry) are browsed recursively,
to locate the manifest file in this directory,
to locate each of the files referenced in the manifest file,
to hash all of the files, including the manifest file.

1. Method for authenticating applications of a computer system comprising: a microprocessor; a plurality of applications; an open generalist operating system capable of executing and managing said applications, and especially to associate to each application identifier an information required to execute it, called the “Identification Information”; a Trusted Environment offering services to said applications; a software component, called a Driver, permitting access to the Trusted Environment from the operating system,
wherein as this method executes prior to any access to the services of the Trusted Environment by an application, it comprises the following operating phases:
the Driver supplies the operating system with the identifier of the application;
the operating system sends back to the Driver certain information that is required to execute the application, called the Identification Information;
the execution of a condensation operation on the Identification Information of said application by a “hashing” Driver, using a cryptographic hashing function and a Condensed result is sent to the Trusted Environment;
the verification by the Trusted Environment of the authenticity of the Condensed result, of said Condensed “hashing” operation,
said method using a software component or Driver which controls a switch from the operating system to the Trusted Environment and which is designed to carry out the following operations:
an interception of an access requests from a non-secure application to a secure service that is executed in the Trusted Environment,
following an interception of an access request, the identifier of the application is sent to the operating system and the request to said system for a file that corresponds to its executable code,
the execution of a hashing operation on the file provided by the operating system, and
the transmission of the condensed result of this “hashing” operation to the Trusted Environment for said verification.

2. Method according to claim 1, wherein the Identification Information comprises at least the executable code of the application.

3. Method according to claim 2, wherein the Identification Information also comprises at least certain file names and certain files used by the application.

4. Method according to claim 1, wherein the verification of the authenticity of the Condensed result by the Trusted Environment is carried out by a search in a list of acceptable Condensed results.

5. Method according to claim 1, wherein the authentication operation verifications are carried out in a prior “log-in” (or saving) phase, which permits the application to be authenticated prior to any request for access to the services of the Trusted Environment.

6. Method according to claim 1, wherein depending on the result of the verification of the Condensed result, the Trusted Environment grants the application different rights of access to its services.

7. Method according to claim 1, wherein the services offered by the Trusted Environment comprises at least the access to certain resources of the computer operating system.

8. Method according to claim 7, wherein the resources of the computer operating system, to which the access is controlled by the Trusted Environment comprise cryptographic encoding means.

9. Method according to claim 8, wherein the resources of the computer operating system, to which the access is controlled by the Trusted Environment, comprise rights to use contents.

10. Method according to claim 1, wherein the Trusted Environment is executed in a secure microprocessor mode.

11. Method for authenticating applications of a computer system comprising: a plurality of applications; an open generalist operating system capable of executing and managing said applications, and especially to associate to each application identifier the information required to execute it; a Trusted Environment offering services to said applications; a software component, called a Driver (5), managing access to the Trusted Environment from the operating system,
said method comprising:
means of interception by the Driver of the access requests from a non-secure application to a secure service that is executed in the Trusted Environment;
means of supplying by the Driver to the operating system the identifier of the application intercepted;
means of returning by the operating system to the Driver certain information required to execute the application, called Identification Information;
means of execution by the condensation by the Driver of a “hashing” operation on the Identification Information using a cryptographic hashing function and of transmission of the result, called “Condensed”, to the Trusted Environment;
means for verifying the authenticity of said Condensed result by the Trusted Environment.

12. System for authenticating applications of a computer system comprising: a plurality of applications; an open generalist operating system capable of executing and managing said applications, and especially to associate to each application identifier the information required to execute it; a Trusted Environment offering services to said applications; a software component, called a Driver, managing access to the Trusted Environment from the operating system, said system being executed on a portable device such as a mobile telephone, or an audio or video player, or a PDA and comprising
means of interception by the Driver of the access requests from a non-secure application to a secure service that is executed in the Trusted Environment;
means of supplying by the Driver to the operating system the identifier of the application intercepted;
means of returning by the operating system to the Driver certain information required to execute the application, called Identification Information;
means of execution by the condensation by the Driver of a “hashing” operation on the Identification Information using a cryptographic hashing function and of transmission of the result, called “Condensed”, to the Trusted Environment;
means for verifying the authenticity of said Condensed result by the Trusted Environment.
